(19) United States
(12) Patent Application Publication
(10) Pub. No.: US 2016/0263583 A1
(43) Pub. Date: Sep. 15, 2016

(54) DEVICE FOR PROCESSING FRACTURING SAND FROM AGGREGATE

(71) Applicants: Murray J. Moran, Biloxi, MS (US); Murray L. Moran, Biloxi, MS (US)

(72) Inventors: Murray J. Moran, Biloxi, MS (US); Murray L. Moran, Biloxi, MS (US)

(21) Appl. No.: 14/645,884

(22) Filed: Mar. 12, 2015

(51) Int. Cl. B03B 5/62; B07B 1/00

(52) U.S. Cl. CPC B03B 5/623; B07B 1/00

(57) ABSTRACT

The present invention relates to a device for processing an aggregate material into fracturing sand, the device comprising: a screen box comprising an upper compartment adapted to receive an aggregate material from a hydro tube device; a plurality of induction jets connected to the steel box for supplying pressurized water, via spray nozzle heads, to wash the aggregate material through a series of grading screens. The device further comprises a lower compartment to receive a washed aggregate from the upper compartment, and comprises a plurality of screen panels with a predefined size for screening out particles of predetermined size to a sand screw via a 12 inch pipe for receiving a finished cut fracturing sand and washing down the rest of the particles larger than the predetermined size to a conveyor and disposed as waste via a hopper connected to the conveyor.

### FIELD OF THE INVENTION

The present invention generally relates to processing of aggregate particles and more specifically relates to a device for producing fracturing sand from aggregate material including cleaned, separated and polished natural aggregates.

### BACKGROUND OF THE INVENTION

Aggregates are granular materials, either naturally obtained or manufactured, constitutes an important component of infrastructure. Natural aggregate resources primarily comprise of sand, gravel and crushed stone. Secondary aggregates comprises by products from industrial process like blast, electric furnace slags or china clay residues. Development and extraction of natural aggregates are significantly influenced by constraints such as urbanization, zonal regulations, increased costs and environmental concerns.

Natural aggregates consists of rock fragments that are used in their natural state, or are used after mechanical processing such as crushing, washing, and sizing. Crushed stone and sand, and gravel are the two primary sources of natural aggregate, which are used directly in construction or as a raw material for construction products such as concrete and bituminous road materials. Natural aggregate materials also serve as a major source for fracturing sand.

‘Fracturing sand’ or ‘Frac sand’ is a high-purity sand with very durable and round grains. They are of a specific size and are highly specialized for the oil industry. Primarily it is used in the hydraulic fracturing process known as “fracking” to assist in producing or extraction of petroleum fluids such as oil, natural gas and natural gas liquids from rock units that lack adequate pore space for these fluids to flow to a well. Based on the trend of increasing oil prices coupled with natural gas and oil exploration in the Western and Eastern United States, demand for frac sand had increased in the recent years. Methods for mining and preparing frac sand may vary slightly based on deposit location and quality of deposit.

Frac sand is produced in a range of sizes from as small as 0.1 millimeter in diameter to over 2 millimeters in diameter depending on usage requirements. The characteristics of a high quality frac sand which can be used as a petroleum industry proppant include high-purity silica sand, standard grain size, spherical shape, turbidity, acid solubility and durability to resist crushing forces of closing fractures. Traditionally, the aggregate materials are processed into frac sand by running the cleaned aggregate particles across a large shaker screen of approximately 250 sq ft size, the shaker screens are operated using large electric motors, which resulted in space consumption and increased operation costs.

From the prior art, there exists numerous patents relating to frac sand processing apparatus and methods. For example: US patent publication no. 20140037962A shows an apparatus and a process for producing frac sand having a predetermined size range and sphericity from a feedstock material. US patent publication no. 20130233545 shows a manufacturing process of self-suspending proppants for hydraulic fracturing. U.S. Pat. No. 8,235,313 B2 discloses a method of making spherical proppant having a selected grade from a naturally occurring, mined granular minerals. US patent publication no. 20140044967 shows a system for producing and processing an aggregate. However, existing frac sand processing or production devices comprises limitations including large screen size, operational complexity, high operational costs, complex machinery involving electric and/or mechanical parts, and the like.

Accordingly, there exists a need for an improved device and method for efficient processing of aggregate material into frac sand with uniform grain size, at high throughput.

### SUMMARY OF THE INVENTION

The present invention relates to a device for processing an aggregate material into fracturing sand, the device comprising: a screen box comprising an upper compartment adapted to receive an aggregate material from a hydro tube device; a plurality of induction jets connected to the steel box for supplying pressurized water, via spray nozzle heads, to wash the aggregate material through a series of grading screens. The device further comprises a lower compartment to receive a washed aggregate from the upper compartment, and comprises a plurality of screen panels with a predefined size for screening out particles by washing down the particles of a predetermined size via a pipe to a sand screw for stacking a finished cut fracturing sand, and particles larger than the predetermined size are conveyed as waste to a hopper for disposal.

The device of the present invention improves the cut of the fracturing sand, without involving mechanical or electrical moving parts but utilizing the gravity of pressurized water and grading screens with predetermined mesh size for separation of particles according to different sizes from the aggregate material.

### BRIEF DESCRIPTION OF DRAWINGS

FIG. 1 is a front view of the device for processing an aggregate material into fracturing sand, according to an embodiment of the invention.

FIG. 2 is a side view of the device for processing an aggregate material into fracturing sand, comprising two units in combination, according to an embodiment of the invention.

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

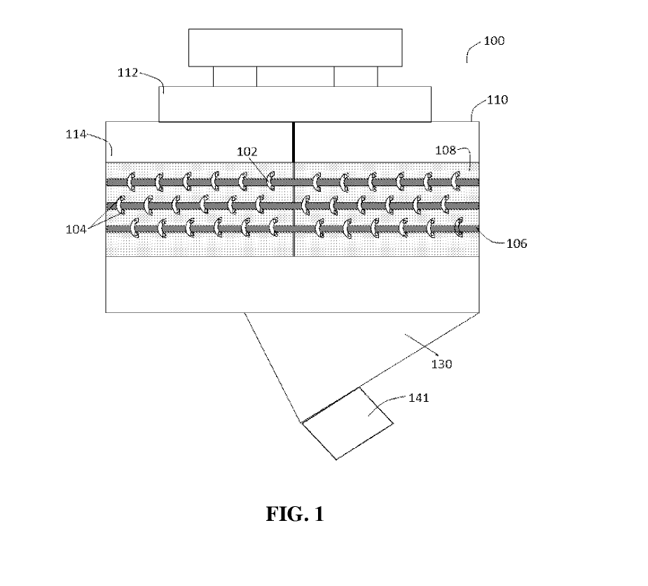

Referring to FIG. 1, which shows a front view of the device for processing an aggregate material into fracturing sand, the device 100 comprising: a screen box 110 comprising an upper compartment 112 adapted to receive an aggregate material from a hydro tube device (not shown). A plurality of induction jets 102 distributed over a water manifold 106, operatively connected to the screen box 110 for supplying pressurized water, via spray nozzle heads 104, to wash the aggregate material through a series of grading screens. The device 100 further comprises a lower compartment 114, adapted to receive a washed aggregate from the upper compartment 112, wherein the lower compartment 114 comprises a plurality of screen panels 108 with a predefined size for screening out particles larger than a predetermined size to a conveyor 130. The screen panels 108 washes down particles equal to or smaller than the predetermined size to a sand screw (not shown) via a 12 inch pipe (not shown) for stacking of finished cut fracturing sand, whereas aggregate materials larger than predetermined size are received at a hopper 141 via the conveyor 130 and disposed as a waste.

The screen panels 108 comprises a plurality of grading screens which are set on an oblique angle, preferably around 60 degrees, thereby allowing gravity movement of the aggregate material with assistance of the water from spray nozzles. In an embodiment, the plurality of screen panels are located at a distal end of the device and are replaceable with grading screens with desired mesh size.

The water manifold 106 is adapted to receive pressurized water from a water pump through a plurality of induction hoses. The pressure of the supplied water can be controlled by a pressure gauge. In general, natural aggregate material comprises of stone, sand and gravel. In an embodiment, the aggregate material received from the hydro tube device cleaned, separated and polished aggregate.

Further, the screen panels are selectable with pores of different shapes and sizes which enables fine tuning of the required fracturing sand size. In an embodiment, the screen panels comprises preferable size of about 64 square feet area and a mesh size of 1.2 millimeter. However, the mesh size differs according to the preferred cut of finished fracturing sand.

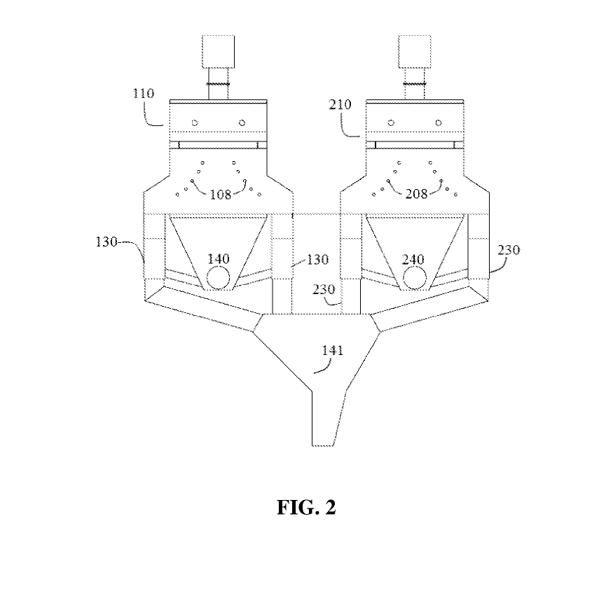

FIG. 2 illustrates a side view of the device comprising two screen boxes in combination, for processing an aggregate material into fracturing sand, according to a different embodiment. The device comprises a first screen box 110 and a second screen box 210 connected together in operation. Each of the screen box 110 and 210 comprises upper and lower compartment with grading screens or screen panels 108, 208 respectively for separating particles according to a predetermined size, which are passed through a 12 inch pipe 140, 240 below the grading screens 108, 208 to a sand screw for stacking of a finished product, for example 30/70 cut fracturing sand. On the other hand, aggregate particles larger than the predetermined size such as pebbles are passed through conveyors 130 and 230 respectively to a hopper 141, configured to collect the waste.

The screen box further comprises a water manifold adapted to supply pressurized water through induction jets for screening aggregate particles based on size, for example: a predetermined size of and less than 1.2 millimeter is washed through the screens 108 into a bend/hopper and 12″ pipe 140 which directs the finished frac sand to a sand screw to stack the finished frac sand.

In an embodiment, wherein the plurality of induction jets supplying pressurized water via induction jets attached to the water manifold is configured to supply water at a preferable pressure range around 55 psi and at a rate of 500 gallons of water per minute.

The device of the present invention can be constructed with any suitable material. By way of non-limiting example, the parts of the device can be manufactured using a variety of standard steel alloys which are able to withstand stress and dynamic load associated with the present invention. The water pump and water induction hoses can be selected based on the desired volume and pressure of water to be introduced into the manifold. Similarly, the pressure gauges can be selected based on the hydraulic pressure deployed through the water manifold and induction hoses.

Advantages of the device of present invention includes but not limited to, usage of screen panels of only 64 sq. ft. in size for separating aggregate particles, whereas traditional screening involves a large shaker screen of 250 sq. ft. Another advantage of the device of present invention includes absence of mechanical or electrical moving parts, instead the current device utilizes the gravity of pressurized water for grading and separation of aggregate material.

In an exemplary embodiment, the device is capable of removing 95% of other materials and exhibits cost effectiveness due to high productivity. For example, the device produces 140 tons of 20/70 cut sand per hour. The merits of the current device may also decrease the cost of the end product, fracturing sand.

The present invention has been described with a preferred embodiment thereof and it is understood that many changes and modifications to the described embodiment can be carried out without departing from the scope and the spirit of the invention that is intended to be limited only by the appended claims.

1. A device for processing an aggregate material into fracturing sand, the device comprising:
a screen box comprising an upper compartment adapted to receive an aggregate material from a hydro tube device;
a plurality of induction jets operatively connected to the screen box for supplying pressurized water, via spray nozzle heads, to wash the aggregate material through a series of grading screens;
a lower compartment, adapted to receive a washed aggregate from the upper compartment, further comprises a plurality of screen panels with a predefined size for screening out particles of a predetermined size and convey to a sand screw adapted to receive a finished cut fracturing sand and washing down remaining particles to a hopper via a conveyor.

2. The device of claim 1, wherein the aggregate material comprises stone, sand and gravel.

3. The device of claim 1, further comprises a water manifold with a plurality of pressure gauges in fluid connection with the spray nozzle heads.

4. The device of claim 1, wherein the plurality of induction jets are adapted to supply pressurized water at 55 psi pressure.

5. The device of claim 1, wherein the plurality of induction jets are adapted to supply pressurized water at a rate of 500 gallons of water per minute.

6. The device of claim 1, wherein the screen box and its compartments are gravity fed and comprise no mechanical moving parts.

7. The device of claim 1, wherein the plurality of screen panels are set on an oblique angle of 60 degrees allowing gravity movement of the aggregate material with assistance of the water from spray nozzles.

8. The device of claim 1, wherein the plurality of screen panels are located at a distal end of the device.

9. The device of claim 1, wherein the plurality of screen panels are removable or replaceable, allowing fine tuning of the fracturing sand size.

10. The device of claim 1, wherein the plurality of screen panels are selectable with pores of different shapes and sizes.

11. The device of claim 1, wherein the plurality of screen panels comprises 64 square feet area.

12. The device of claim 1, wherein the plurality of screen panels comprises 1.2 millimeter mesh size.

13. The device of claim 1, wherein the aggregate material received from the hydro tube device comprises cleaned, separated and polished natural aggregate.

14. The device of claim 1, wherein the finished cut fracturing sand comprises a 20/70 fracturing sand.
